(19) United States
(12) Patent Application Publication
(10) Pub. No.: US 2025/0146664 A1
(43) Pub. Date: May 8, 2025

(54) Ammonia And Low Btu Bio-Fuel Combustion In A Furnace With Thermochemical Heat Exchanger

(71) Applicant: Hisashi Kobayashi, BEDFORD, NY (US)

(72) Inventor: Hisashi Kobayashi, BEDFORD, NY (US)

(21) Appl. No.: 18/924,324

(22) Filed: Oct. 23, 2024

Related U.S. Application Data
(60) Provisional application No. 63/595,931, filed on Nov. 3, 2023.

(51) Int. Cl. F23L 15/02; F23L 7/00; F27D 17/00

(52) U.S. Cl. CPC F23L 15/02; F23L 7/007; F27D 17/10; F23L 2900/07005; F27D 17/13

(57) ABSTRACT

Disclosed is a thermochemical regenerative combustion method for fuel containing ammonia and/or other low BTU bio-fuels to achieve fuel efficiency equal to or better than conventional fuels such as hydrogen and natural gas.

### RELATED APPLICATIONS

This application claims the benefit of priority from U.S. Application Ser. No. 63/595,931 filed on Nov. 3, 2023, which is incorporated herein by reference.

### FIELD OF THE INVENTION

The present invention relates to a novel combustion process to use ammonia and low-BTU bio-fuels with oxygen in industrial furnaces for the reduction of CO₂ emissions and fuel consumption by incorporating a thermochemical heat exchanger to recover and recycle heat from furnace combustion products.

### BACKGROUND OF THE INVENTION

Many industrial processes such as glass manufacture require establishing and maintaining high temperatures within a furnace or other similar equipment. Often, the high temperature is established by combustion of a fuel, such as natural gas, as a means of supplying heat and energy for various process needs. Typically, natural gas is combusted with an oxidant to release the fuel's chemical energy, thereby forming single or multiple high temperature flames within the furnace. Heat from the flame is transferred to process loads for a variety of purposes, such as to produce high pressure steam for electricity generation or to melt raw materials for making glasses and metals.

This combustion generates high temperature flue gas streams. Since combustion of conventional fossil fuels such as natural gas and oil emit large amounts of CO₂ as part of a flue gas or flue gas stream, new combustion technologies to at least partially or more preferably fully replace fossil fuels with CO₂ neutral fuels are currently being developed. Hydrogen (H₂) is considered an important fuel of the future as it does not emit CO₂ during combustion. However, hydrogen requires a low cryogenic temperature to liquefy, and hence is expensive to transport over the ocean by ship. Ammonia (NH₃) also is considered a valuable fuel, as it does not emit CO₂ during combustion and can be liquified at ambient temperature at a modest pressure and can be transported economically by ship. Low BTU bio-fuels such as biomass pyrolysis oils, ethanol produced from corn or sugarcane fermentation are also considered CO₂ neutral fuels and wider applications are currently being developed for their respective commercial utilization. Raw bio-fuels usually contain large water fractions and have low adiabatic flame temperatures. In the following description herein and throughout, it should be understood that “low BTU bio-fuel” is defined as a biomass derived fuel that has an adiabatic flame temperature less than 1850° C. The adiabatic flame temperature of a fuel is defined as the temperature of the combustion products when the fuel is combusted with dry air at one atmosphere, at 25° C., and at the stoichiometric ratio without any heat losses to the surroundings. The adiabatic flame temperature is indicative of required fuel input in high temperature furnaces as will be explained hereinbelow. Adiabatic flame temperature of a fuel changes with oxidant properties. For example, preheated air and oxygen increase adiabatic flame temperature of a fuel in comparison to the adiabatic flame temperature of the same fuel combusted with dry air at one atmosphere, at 25° C., and at the stoichiometric ratio without any heat losses to the surroundings. However, the relative magnitude of adiabatic temperatures of different fuels do not change when oxidant properties are changed from the defined standard air properties. Thus, adiabatic flame temperature defined with the standard air properties hereinabove is a meaningful parameter that can be used as a combustion characteristic of a fuel that allows for comparison of different fuels based on their respective adiabatic flame temperatures.

The use of ammonia as a fuel in high temperature industrial furnaces poses two technical challenges of (1) low fuel efficiency and (2) high NOx emission. In this regard, ammonia has a low adiabatic flame temperature of about 1800° C. and a low available heat at high temperature. Low BTU bio-fuels such as raw ethanol liquid from corn or sugarcane fermentation and biomass pyrolysis oils contain a significant amount of water and their adiabatic flame temperatures are low. As a result, the fuel requirement in high temperature furnaces become higher than the fuel requirement for natural gas or hydrogen. The second drawback is that ammonia can be easily oxidized to form NOx emissions at high temperatures, and, therefore, a special combustion method is required to limit NOx formation. One way to avoid both of these technical problems is to dissociate ammonia into hydrogen and nitrogen. (i.e., 2 NH₃->3H₂+N₂) at high temperature prior to its combustion. Dissociated ammonia can be used as a more efficient fuel in comparison to ammonia, or can be further separated as H₂ and N₂, and only hydrogen can be used as a fuel. This dissociation process, however, is highly endothermic and a large amount of additional energy is required. Low BTU bio-fuels containing water can be upgraded by removing water. Separation of water, however, is highly endothermic and a large amount of additional energy is required. It is desirable to find a method to use liquid or gaseous ammonia or other low BTU bio-fuels as an industrial fuel at a fuel efficiency comparable to that achieved by natural gas and hydrogen.

However, currently there is no method to use liquid or gaseous ammonia or low BTU bio-fuels as a high temperature industrial fuel at a fuel efficiency comparable to that achieved by natural gas or hydrogen. FIG. 1 shows a comparison of fuel input required to provide 1 GJ of available heat at different flue gas temperatures for ammonia, dissociated ammonia (“D-NH₃”), methane and hydrogen combusted with dry air at 25° C. Methane (CH₄) is the majority-containing chemical species in natural gas and therefore the combustion properties of natural gas are well represented with that of pure methane. In high temperature industrial furnaces, large amounts of heat generated by combustion is consumed to heat the combustion products to the furnace temperature, which exits the furnace as flue gas. As a result, the fuel input to provide a unit amount of usable heat (i.e., available heat) in the furnace increases sharply at high temperature. At the adiabatic flame temperature of the fuel, all of the combustion heat generated with dry air at 25° C. and at one atmosphere in a furnace is used to heat the combustion products and the available heat in the furnace becomes zero by definition. Ammonia (NH₃) has a low adiabatic flame temperature and the available heat at high temperature becomes much lower than methane. Low BTU bio-fuels also have low adiabatic flame temperature and the available heat at high temperature becomes much lower than methane. The fuel input required to provide 1 GJ of available heat becomes much higher than methane. In contrast, hydrogen (H₂) has a higher adiabatic flame temperature of about 2200° C. with air combustion. It is higher than the adiabatic flame temperature of about 1950° C. for methane-air combustion and the fuel input required for hydrogen becomes lower than methane under combustion with air. FIG. 1 shows that at a flue gas temperature of 1100° C., the amount of ammonia fuel input is 17% more than methane fuel input, while the use of hydrogen reduces the fuel requirement by 11% as compared to methane. The differences in the fuel requirements become much larger at higher flue gas temperatures, for example, at or above 1250° C. and at or above 1400° C. . . . Although not shown in FIGS. 1-3, low BTU bio-fuels also show high fuel input requirements similar to ammonia fuel. Dissociated ammonia (“D-NH₃”) is produced by dissociating ammonia in a separate high temperature process and can be used as a gaseous fuel. When fully dissociated, D-NH₃ is a 3:1 mixture of hydrogen and nitrogen, the required fuel input in the furnace becomes close to that of methane. However, the ammonia dissociation process requires a relatively large amount of energy, which has to be accounted for when comparing furnace fuel efficiencies with other fuels. In order for ammonia and low BTU bio-fuels to be used economically in high temperature furnaces, the heat input required or the furnace energy efficiency has to be improved.

Recuperators to preheat combustion air are widely used to recover and recycle a portion of the sensible heat in the flue gas. The adiabatic flame temperature and the available heat in the furnace increase with preheated air combustion. FIG. 2 shows the reduced fuel requirements relative to FIG. 1, when combustion ambient air (25° C.) is replaced with preheated air at 538° C. For ammonia and methane, the fuel requirements at 1100° C. are reduced from 2.5 GJ to 1.7 GJ and from 2.1 GJ to 1.5 GJ respectively by preheating the combustion air to 538 C. The difference in the fuel requirement between ammonia and methane is reduced from 17% to 7% by the flue gas heat recovery to preheat the combustion air to 538° C. When the furnace flue gas temperature is higher, the differences in the fuel requirements become larger, for example, at or above 1250° C. and at or above 1400° C.

Oxy-fuel combustion or combustion of fuel with industrial oxygen containing 50 to 100% O2 is used in high temperature industrial furnaces to reduce fuel consumption and to reduce NOx emissions. Oxy-fuel combustion reduces the nitrogen in the combustion air and the heat lost in the combustion flue gas is reduced, which enables the reduction of fuel input especially in high temperature furnaces. FIG. 3 shows the reduced fuel requirements relative to FIG. 2 when preheated combustion air is replaced with pure oxygen. For ammonia and methane, the fuel requirements are reduced from 1.7 GJ to 1.33 GJ and from 1.5 GJ to 1.21 GJ respectively by the use of pure oxygen for combustion. However, the relative difference in the fuel requirement between ammonia and methane is increased from 7% to 10% by replacing the preheated combustion air at 538° C. with pure oxygen at ambient temperature. By comparison, the fuel requirement of hydrogen combustion with pure oxygen becomes close to that of methane-oxygen combustion. When the furnace flue gas temperature is higher, the differences in the fuel requirements become larger, for example, at or above 1250° C. and at or above 1400° C. In higher temperature industrial furnaces with flue gas temperature above 1500° C., the difference in fuel requirement between ammonia and methane or between ammonia and hydrogen can be as large as 20% under oxy-fuel combustion.

In view of the aforementioned drawbacks, there remains a need to find improved methods to combust ammonia and other low BTU bio-fuels with oxygen at higher fuel efficiencies in high temperature industrial furnaces. The present invention feeds this need.

### BRIEF SUMMARY OF THE INVENTION

One aspect of the present invention is a method of carrying out combustion in a furnace, comprising
(A) combusting a reformed fuel formed in step B (1) and step B (2) in a furnace to produce gaseous combustion products, and
(B) alternately
(1) passing the gaseous combustion products from the furnace into and through a cooled first regenerator to heat the first regenerator and cool said gaseous combustion products, and passing a fuel comprising ammonia into a heated second regenerator heated in step B (2) and, in the second regenerator, heating said fuel comprising ammonia and dissociating ammonia to form a reformed fuel, thereby cooling said second regenerator, and passing said reformed fuel from the second regenerator into the furnace and combusting the reformed fuel in the furnace, and
(2) passing the gaseous combustion products from the furnace into and through a cooled second regenerator to heat the second regenerator and cool said gaseous combustion products, and passing a fuel comprising ammonia into the heated second regenerator heated in step B (1) and, in the first regenerator, heating said fuel comprising ammonia and dissociating ammonia to form a reformed fuel thereby cooling said first regenerator, and passing said reformed fuel from the first regenerator into the furnace and combusting the reformed fuel in the furnace.

A second aspect of the present invention is a method of carrying out combustion in a furnace, comprising:
(A) combusting a fuel product in the furnace to produce combustion products at temperature above 1100° C.; and
(B) passing the combustion products from the furnace into a thermochemical regenerator system to transfer heat from said combustion products to an ammonia-based fuel;
(C) cooling said gaseous combustion products and heating said ammonia-based fuel, thereby allowing said ammonia-based fuel to dissociate into a fuel product;
(D) passing the fuel product into the furnace; and
(E) exhausting all of the cooled gaseous combustion products to a stack.

A third aspect of the present invention is a method of carrying out combustion in a furnace, comprising:
(A) combusting with oxygen a reformed fuel formed in step B (1) and step B (2)—to produce gaseous combustion products at a temperature above 1100° C., and
(B) alternately
(1) passing the gaseous combustion products from the furnace into and through a cooled first regenerator to heat the first regenerator and cool said gaseous combustion products, and passing a fuel with an adiabatic flame temperature with stoichiometric air combustion of less than 1850° C. into a heated second regenerator heated in step B (2) and, in the second regenerator, heating and transforming said fuel to form a reformed fuel, thereby cooling said second regenerator, and passing said reformed fuel from the second regenerator into the furnace and combusting the reformed fuel in the furnace, and
(2) passing the gaseous combustion products from the furnace into and through a cooled second regenerator to heat the second regenerator and cool said gaseous combustion products, and passing a fuel with an adiabatic flame temperature with stoichiometric air combustion of less than 1850° C. into a heated first regenerator heated in step B (1) and, in the first regenerator, heating and transforming said fuel to form a reformed fuel, thereby cooling said first regenerator, and passing said reformed fuel from the first regenerator into the furnace and combusting the reformed fuel in the furnace.

### BRIEF DESCRIPTION OF THE DRAWINGS

FIG. 1 shows a comparison of fuel input required to provide 1 GJ of available heat at different flue gas temperatures for ammonia, dissociated ammonia (“D-NH₃”), methane and hydrogen combusted with dry air at 25° C.;

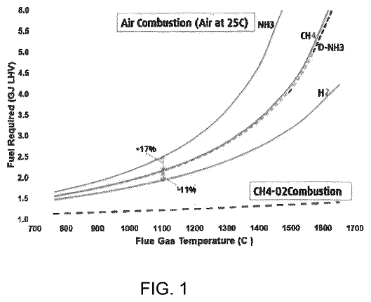

FIG. 2 shows the reduced fuel requirements in comparison to FIG. 1 when combustion air is replaced with preheated air at 538° C.;

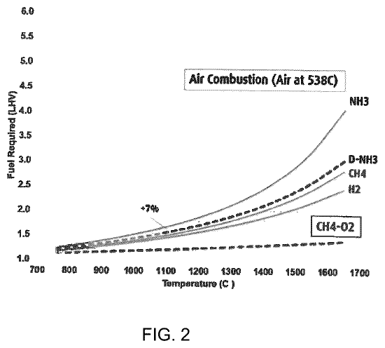

FIG. 3 shows the reduced fuel requirements relative to FIG. 2 when preheated combustion air is replaced with pure oxygen;

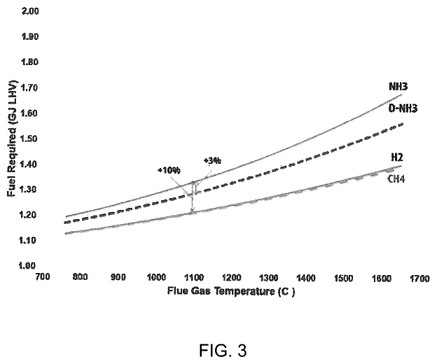

FIG. 4 is a generalized schematic representation of one aspect of the heat recovery process of the present invention;

FIG. 5 is a process flow schematic of an oxy-fuel fired glass melting furnace with two thermochemical regenerators that alternate to receive a fuel stream in accordance with the principles of the present invention;

FIG. 6 shows one of the regenerators of FIG. 5 operating in a flue cycle mode to accumulate heat in accordance with the principles of the present invention; and

FIG. 7 shows the other regenerator of FIG. 5 operating in a dissociation cycle whereby a fuel stream is fed into the regenerator in accordance with the principles of the present invention.

### DETAILED DESCRIPTION OF THE INVENTION

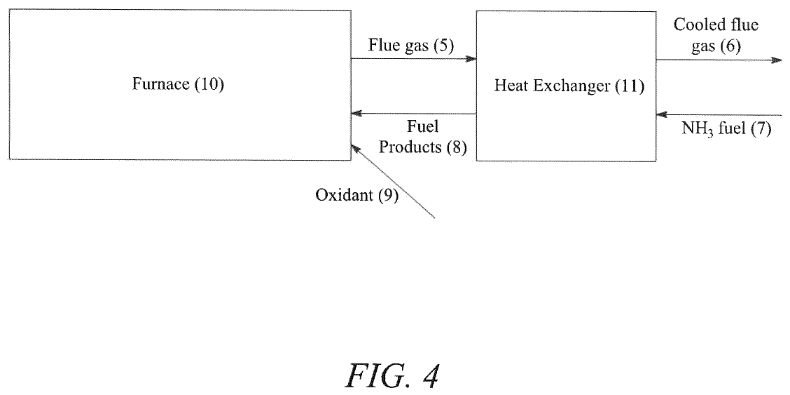

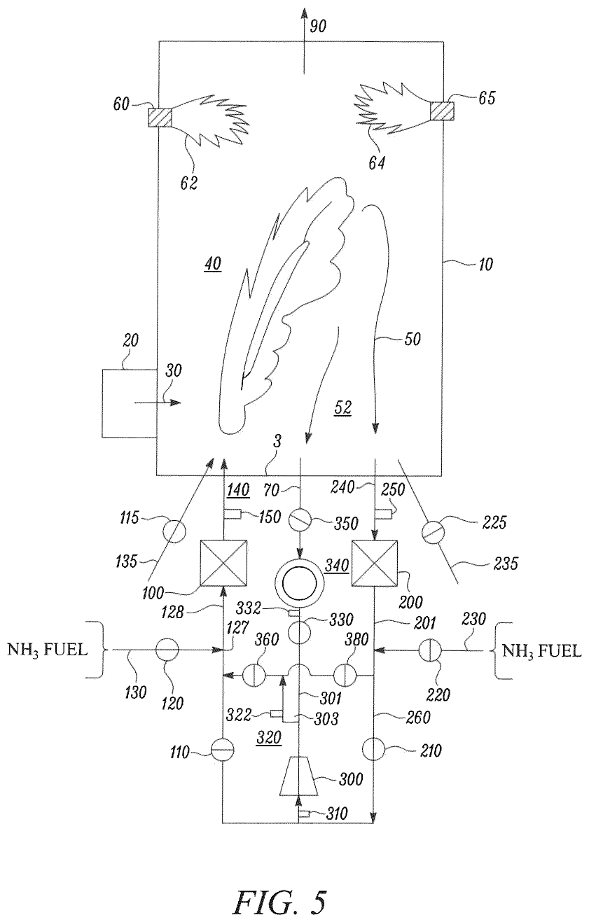

The present invention employs a thermochemical heat recovery process for the flue gas exhausted from a high temperature industrial furnace that involves combusting an ammonia fuel containing more than 10% ammonia as measured in lower heating value input, and more preferably containing 50% to 100% ammonia, with oxygen as the oxidant. The thermochemical heat recovery process can be generally described with reference to FIG. 4, which illustrates a heat recovery heat exchanger (11) that is operably connected to a high temperature combustion chamber of a furnace (10) such as a glass melting furnace, a steel reheat furnace or a cement kiln. It should be understood that FIG. 4 represents a simplified diagram whereby the heat recovery heat exchanger (11) is intended to designate a thermochemical regenerator system (“TCR”) which includes the first regenerator (100) and second regenerator (200) of FIG. 5. Combustion takes place in furnace (10) by injecting oxidant (9) and fuel products (8) formed by thermochemical reactions in counter-current heat exchanger (11). Flue gas (5) is produced that exits furnace (10) at a high temperature and enters the heat recovery heat exchanger (11). The flue gas (5) may also contain other gases generated from materials heated or melted in the furnace (10). An ammonia fuel stream (7) is fed into the heat recovery heat exchanger (11) as the low temperature stream which is utilized to recover heat from the high temperature flue gas stream (5) from the furnace (10). Industrial oxygen containing more than 50% O2 by volume is used as oxidant (9) in the present invention. It should be understood all percentages as stated herein are based on volume or a molar basis, unless stated otherwise. The counter-current heat exchanger (11) is preferably either a recuperator which transfers heat continuously through heat transfer surfaces (e.g., walls) separating two heat exchanging streams or regenerators (e.g., checker-filled regenerators) which store heat in heat storage media, typically refractory bricks, to transfer heat from the high temperature flue gas stream (5) and then transfer heat from the heat storage media to the low temperature ammonia fuel stream (7) in a cyclic fashion. It should be understood that the present invention can be carried out by utilizing ammonia fuel in gaseous phase or liquid phase and that reference to “ammonia fuel” or “ammonia-based fuel” or “ammonia containing fuel” may be used interchangeably herein and throughout to mean a gaseous phase or liquid phase of ammonia with or without other fuels therein as will be described by way of non-limiting examples in Tables 1 and 2.

Where a range of values describe a parameter, all sub-ranges, point values and endpoints within that range or defining a range are explicitly disclosed therein. All physical properties, parameters, dimensions, and ratio ranges and sub-ranges (including endpoints) between range end points for those properties, parameters, dimensions, and ratios are considered explicitly disclosed herein.

Examples of combustion processes with which the method of the present invention can be practiced include, but are not limited to, oxy-fuel fired glass melting furnaces, in which glass-forming ingredients are melted together to form molten glass. In a preferred embodiment of the present invention, an oxy-fuel fired glass melting furnace with two thermochemical regenerators is used as will be explained in conjunction with FIGS. 5-7.

U.S. Pat. No. 6,113,874, which is hereby incorporated in its entirety by reference for all purposes, teaches a thermochemical heat recovery process using the endothermic dissociation and reforming reactions of methane (CH4) with water vapor (H2O) and carbon dioxide (CO2) contained in the flue gas of oxy-fuel combustion. This process requires a complex flue gas recycling and mixing step to facilitate the endothermic chemical reactions to recover a portion of the sensible heat in the flue gas from the furnace. The present invention represents a departure from U.S. Pat. No. 6,113,874, whereby in the present invention, this flue gas recycling step for mixing recycled flue gas with the fuel during the reforming cycle is totally or partially eliminated by replacing many hydrocarbon fuels with an ammonia-containing fuel or low BTU bio-fuels to improve the heat recovery efficiency.

In the present invention, this heat recovery process proceeds in two cycles, which are referred to herein as the flue cycle and the dissociation cycle (i.e., reforming cycle). These two cycles are preferably performed alternatingly in two or more checker-filled regenerators. The heat recovery process is preferably carried out in association with furnaces and other combustion devices, which employ “oxy-fuel” combustion processes, i.e., combustion of fuel with gaseous oxidant comprising an oxygen content of at least 50 vol. % oxygen, and preferably at least 80 vol. % oxygen, more preferably at least 90 vol. % oxygen, and most preferably at least 99 vol. % oxygen. During the flue cycle, the checkers in a first regenerator extract stored heat from a high temperature flue gas stream which is fed from the furnace into and through this first regenerator.

In the dissociation cycle, ammonia fuel enters a second regenerator in which the checker has already been heated, as described herein, and flows through it towards the furnace. The temperature of the ammonia fuel passing through the second regenerator continues to increase by extracting heat from the pre-heated checker. As the ammonia fuel passes through the second regenerator, it reaches a temperature at which dissociation reactions begin to occur and continue to occur, producing fuel products typically including H2 and N2, unreacted ammonia (NH3) and other species. The ammonia dissociation reactions are endothermic, and the heat needed to promote the dissociation reactions is absorbed from the pre-heated checker. The gaseous composition thus produced may also be referred to as “reformed gas” herein. The reformed gas emerges from the second regenerator and is fed into the furnace where it is combusted with oxidant to provide thermal energy for heating and/or melting material in the furnace.

After a length of time, the operation of the two regenerators is reversed, i.e., the first regenerator that was used in the flue cycle is switched to the dissociation cycle, and the second regenerator that was used in the dissociation cycle is switched to the flue cycle. After a further period of time, the operation of the two regenerators is reversed again. The timing of the reversals can be determined by elapsed time, or by other criteria such as the temperature of the flue gas exiting from the first regenerator that is in the flue cycle. The reversal process is preferably carried out according to a predetermined mechanism and plan, wherein valves are sequenced to open and close based on specific timings.

The operation and control of the above-described preferred embodiment of the present invention is described in greater detail below in conjunction with FIGS. 5 to 7. An end-port fired glass furnace (10) fitted with two regenerators in end wall (3) is used as an example. However, it should be understood that any configuration of the regenerators, including rotating regenerators, can be utilized. For example, the operation described herein of a pair of regenerators can be carried out in the same manner when the pair of regenerators are side by side on one side of furnace (10) or are positioned on opposite sides of the furnace (10). In the rotating regenerators, there are two different rotating configurations. The first configuration rotates the heat storing checkers and the stationary gas passages designed for passing the high temperature flue gas stream, the cooled exhausting flue gas stream, the input ammonia fuel stream, and the output reformed gas stream are connected to the heated checker section and the cooled checker section in a cyclical fashion. The second configuration has a stationary checker section and rotates the gas passages designed for passing the cooled exhausting flue gas stream and the input ammonia fuel stream that connect to the heated checker section and the cooled checker section in a cyclical fashion.

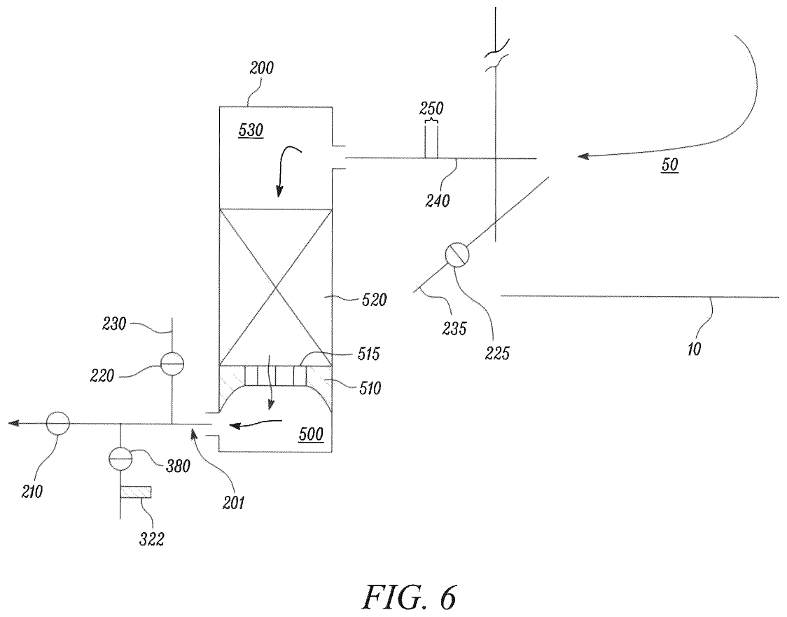

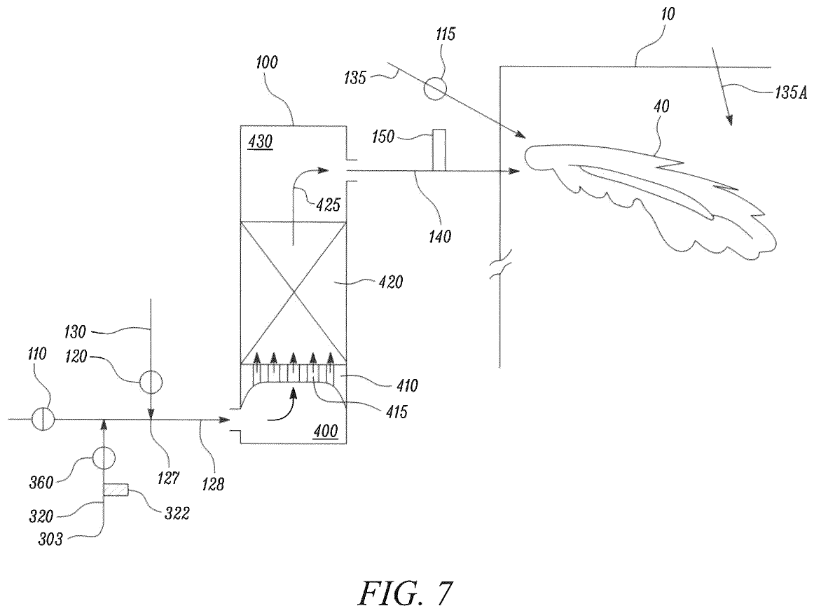

As shown in FIG. 5, end-port glass furnace (10) has a feed station (20) where feed material (30) comprising solid glassmaking materials (known as batch and/or cullet) are charged into the furnace (10) to be heated and melted. The flow of molten glass out of furnace (10) is represented as (90). The furnace (10) is equipped with first regenerator (100) on the furnace left side and second regenerator (200) on the furnace right side. It should be understood that in the description herein and throughout, terms such as left side, right side, downwards, upward, top, bottom, above, below and the like may be used to illustrate spatial orientation in connection with the Figures, and are intended to be used solely for purposes of explaining the present invention and should not be taken as words of limitation. Vertical cross-sectional views of the two regenerators (100) and (200) are displayed in more detail in FIGS. 6 and 7.

As seen in FIG. 6, second regenerator (200) is in the flue cycle wherein flue gas stream (50) from the interior of furnace (10) enters port neck (240) and then flows past an optional oxygen analyzer (250) and then into the top space (530) of second regenerator (200). The flue gas stream (50) heats checkers (represented as (520)) as it flows through passages between the checkers within second regenerator (200), and enters chamber bottom space (500) through gas passages (515) supported on arch (510) which also supports the weight of the whole bed of checkers (520). As seen in FIG. 5, a portion (52) of the flue gases produced in furnace (10) may be by-passed to conduit (70) (for instance, if it is desired to control the regenerator from becoming too hot) through a partially opened valve (350) and then enters stack (340) to exhaust, by which is meant that it does not re-enter the furnace (10), but instead is discharged to the atmosphere and/or conveyed to one or more other stations for storage and/or further treatment or any combination of such destinations. For maximum heat recovery, it is preferred that valve (350) is closed so that essentially all the furnace flue gas goes to second regenerator (200) as flue gas stream (50).

As seen in FIGS. 5 and 6, the cooled flue gas stream (201) exits the second regenerator (200) in conduit (260), passes through an open valve (210) and oxygen sensor (310), and then enters the suction-side of blower (300). The flue gas (301) leaving the pressure-side of the blower passes through a damper (330) then a flow meter (332), and finally is directed into stack (340) through which this cooled flue gas leaves the system to exhaust as defined herein.

As seen in FIG. 7, the ammonia fuel enters the pre-heated checker pack (420) of first regenerator (100) through gas passages (415) on arch (410). First regenerator (100) has already been heated in a previous flue gas cycle by passage of flue gas from the furnace (10) into and through the first regenerator (100). The temperature of the ammonia fuel increases as it flows through the pre-heated checker pack (420) of first regenerator (100). If the ammonia fuel is liquid, it is vaporized and then transforms to gaseous ammonia fuel. When the temperature of the ammonia fuel reaches the ammonia dissociation temperature, endothermic dissociation reactions occur and form H₂, N₂, residual NH₃, and other species. The required heat for the endothermic dissociation reactions is taken from the pre-heated checker pack (420). The dissociation reaction continues as the ammonia fuel continues to travel toward the top space (430). The dissociated fuel stream (425) (i.e., reformed gas stream) exits from the top of checker pack (420) of first regenerator (100). Reformed gas stream (425) has a high temperature and exits pre-heated checker pack (420) at temperatures ranging from 1800 F to 2500 F by way of non-limiting example. The reformed gas stream (425) has a composition that includes species such as NH₃, H₂, N₂, and other fuel species. FIG. 7 shows that the reformed gas stream (425) passes through port neck (140) and optional oxygen sensor (150), and enters furnace (10). This reformed gas stream (425) is combusted in the furnace (10) and is represented as flame (40) to generate additional heat of combustion useful for heating and/or melting material in the furnace (10), such as glassmaking materials. Oxidant required for combustion of the reformed gas stream (425) is supplied by a conduit (135) through opened valve (115). This oxidant has an oxygen content at least 50 vol. %, and preferably equal to or higher than 80 vol. %, more preferably equal to or higher than 90 vol. %, and most preferably at least 99 vol. %.

Typically, the heat recovery process proceeds with one regenerator in the flue cycle and one regenerator in the dissociation cycle, as seen in FIG. 5, for about 20 to 40 minutes, by way of non-limiting example, or until the checkers in the dissociation regenerator are too cold to provide sufficient heat to promote the desired endothermic chemical reactions (i.e., ammonia dissociation chemical reactions). At that point, and now continuing with the description herein where second regenerator (200) is in the flue cycle and first regenerator (100) is in the dissociation cycle (as shown in FIG. 5), furnace (10) undergoes a reversal in which second regenerator (200) is transitioned to the dissociation cycle for heat recovery and first regenerator (100) is transitioned into the flue cycle for heat accumulation. Before the reversal occurs, any remaining reformed gas produced in first regenerator (100) is purged into furnace (10) with a purge gas that does not form a flammable mixture in the bottom zone (400). Preferred purge gases include, but are not limited to, nitrogen, steam, a recycled flue gas (RFG) from the second regenerator (200) (where the RFG is created by a portion (303) of the cooled flue gas recycled to the bottom of first regenerator (100) and passing through conduit (320) and open valve (360)), air and their mixtures. The RFG from the second regenerator (200) is used in this particular embodiment, as a non-limiting embodiment, for purging of any remaining reformed gas in the first regenerator (100). In this regard, the ammonia fuel supplied to the first regenerator (100) is terminated by closing valve (120), while letting the flow of RFG from blower (300) continue. During purging, the RFG flow rate may be increased to shorten the time required for purging of the remaining reformed gas in first regenerator (100) to be completed. Remaining reformed gas in the first regenerator (100) is purged by the RFG for a specified amount of time so that nearly all the reformed gas in the first regenerator (100) is expelled to the furnace (10) and combusted to completion.

After the remaining reformed gas is purged from first regenerator (100), reversal occurs such that first regenerator (100) operates in a flue cycle mode and the second regenerator (200) operates in a dissociation mode (i.e., reforming mode or cycle). In one embodiment, upon reversal, the flue gas (52) from the furnace (10) passes through first regenerator (100), and a portion of the flue gas (52) from the furnace (10) passes to exhaust (as defined hereinabove). Referring to FIG. 5, valve (110) which had been closed is opened, valve (210) is closed, and valve (360) is closed, and valve (330) is opened. This configuration of open and closed valves creates a flow path to permit heated flue gas to pass from the bottom of first regenerator (100) toward and through the suction-side of blower (300), and to permit this flue gas leaving the pressure-side of the blower (300) to pass through open valve (330) and into stack (340). The ammonia-containing fuel (230) enters through valve (220) which had been closed but now is opened. Valve (115) which had been open is closed, as no combustion aided by oxidant through valve (115) occurs in this phase, and valve (225) is opened to allow oxidant to flow therethrough. The ammonia fuel undergoes in regenerator (200) the endothermic reactions (i.e., ammonia dissociation chemical reactions) which had occurred in regenerator (100) in the previous cycle as described hereinabove, to produce reformed gas (425) which passes into furnace (10) where it is combusted with oxidant (235) that is fed through valve (225). Before reversal occurs such that first regenerator (100) once again operates in the dissociation cycle mode and the second regenerator (100) once again operates in the flue cycle mode, any remaining reformed gas produced in second regenerator (200) is purged with RFG into furnace (10) in the same manner described hereinabove. During the heat recovery process, furnace (10) may be co-fired with other burners such as (60) and (65) such that both reformed gas flame (40) and burner flames (62) and (64) co-exist. In addition, burners (60) and (65) may or may not be firing during the reversal process when the dissociation regenerator (100) or (200), as the case may be, is undergoing the purging sequence described above. For maximum heat recovery, it is preferred that burners (60) and (65) are not co-firing with the reformed gas flame (40). It is also preferred that during the purging sequence, burners (60) and (65) are firing.

### PROPHETIC EXAMPLES

Table 1 shows various examples of furnace energy balances and heat transfer analyses for a 300 tpd container glass furnace with a melter area of 100 m2, operating with 50% cullet ratio and 1000 kW electric boosting. Cullet is recycled glass used as a feed material and 50% of glass produced is made from cullet. Case numbers 1, 2, 3, and 4 are calculated for four different fuels. without using any heat recovery systems. In a second scenario, Table 1 shows the results when the fuels are utilized with a thermochemical regenerator system (“TCR”). Case 1 is a baseline prior art example using natural gas, and Case 4 represents the results of the present invention. The furnace energy balances, and heat exchanger heat transfer analyses are performed using a detailed glass furnace energy balance model and a counter current heat exchanger model created by the inventor. The predictions from these models have been shown to agree well with actual industrial furnace data using natural gas and a TCR and therefore are believed to serve as a reliable indicator of actual results shown in the tables. Flue gas exits the furnace at 1445° C. for oxy-fuel firing cases without using TCR (i.e., no portion of the hot flue gas is recycled). Calculated fuel consumptions are 3.52 GJ/t (GJ in lower heating value per one metric ton of glass produced) with natural gas (assumed to contain 100% CH₄ for case number 1) mixed with 1 to 1 volume ratio of RFG; 3.53 GJ/t with hydrogen (H₂) for case number 2; 3.56 GJ/t liquid ethanol [C₂H₅OH (1)] for case number 3; and 4.53 GJ/t with liquid ammonia [NH₃ (1)] for case number 4, when no flue gas heat recovery systems are used. Natural gas is modelled as pure methane (CH₄). Oxidant used for combustion is industrial oxygen with 93% 02, 2.5% N2 and 3.5% Ar by volume and ambient air infiltrated into the furnace. In all cases, the flow rate of the infiltrated air was assumed to be 402 Nm³/h (15,000 SCFH) at 25° C. without moisture (i.e., dry air). The average oxygen concentration of the oxidant consisting of the industrial oxygen and infiltrated air was about 80 to 85%. Cases 2 and 3 show fuel requirements close to the baseline natural gas Case 1. However, when liquid ammonia is used, the fuel consumption increases sharply to 4.53 GJ/t, which is higher than methane by about 29%.

Table 1 also shows fuel consumption when a TCR heat recovery system is used. The heat transfer analysis of the TCR for Case 1 shows 50.4% of the sensible heat in the flue gas is transferred to the fuel (i.e., RFG-CH₄ mixture), which is recycled to the furnace as the sensible heat and chemical energy of the reformed gas formed. 8.2% of the sensible heat in the flue gas is lost as wall heat losses. The remaining 41.4% of the sensible heat exits the TCR at a temperature of 680 C. Thus, the heat exchanger efficiency is 50.4% % in Case 1. As a result, specific fuel consumption is reduced to 2.84 GJ/t, providing 19.3% fuel savings relative to the Oxy-CH₄ baseline. Case 2 shows the same furnace is fired with hydrogen (H₂) and with the same TCR heat recovery system without RFG. H₂ is simply heated in the TCR without chemical reactions. The heat transfer analysis of TCR for H₂ preheating shows that 40.9% of the sensible heat in the flue gas is transferred to the fuel (i.e., H₂) and recycled to the furnace as the sensible heat of hydrogen at 1200° C. As a result, fuel consumption is reduced to 2.95 GJ/t, providing 16.3% fuel savings relative to the Oxy-H₂ baseline without heat recovery system. Case 3 shows the same furnace is fired with the reformed gas from liquid ethanol [C₂H₅OH (1)] with the same TCR heat recovery system and without blending RFG during the reforming cycle. Ethanol is vaporized in the TCR and then assumed to decompose at a higher temperature to form ethylene and water vapor (i.e., C₂H₅OH (g)->C₂H₄+H₂O). The heat transfer analysis of TCR for ethanol shows that 51.8% of the sensible heat in the flue gas is transferred to the fuel (i.e., ethanol) and recycled to the furnace. As a result, fuel consumption is reduced to 2.86 GJ/t, providing 19.6% fuel savings relative to the oxy-ethanol baseline without heat recovery system.

Case 4 shows the same furnace is fired with the reformed gas from liquid ammonia [NH₃ (1)] with the same TCR heat recovery system and without blending RFG during the reforming cycle. The furnace energy balance and the heat transfer analysis of TCR for ammonia shows that ammonia is vaporized first in the low temperature zone of the TCR and then 64% of ammonia dissociates at higher temperature to form the reform gas containing hydrogen, nitrogen, and residual ammonia. The reform gas is assumed to be heated to 1200° C. in the TCR and combusted in the furnace. 74.1% of the sensible heat in the flue gas from the furnace is transferred to the fuel (i.e., ammonia) and recycled to the furnace in this case. The inventor unexpectedly discovered a large reduction in fuel consumption to 2.86 GJ/t, providing 37.2% fuel savings relative to the oxy-ammonia baseline without heat recovery system. While the inventor does not wish to be bound by any theories, the unexpected large fuel savings achieved for ammonia fuel combustion with oxygen with the TCR is enabled by the low adiabatic flame temperature of ammonia as compared to that of a common fuel such as methane. By definition, a fuel with low adiabatic flame temperature produces flue gas with a large sensible heat energy at high furnace gas temperature. Ammonia fuel requires a large energy to dissociate to form hydrogen and nitrogen. The thermochemical regenerators (TCR) of the present invention properly balanced the sensible heat available in the flue gas to the heat required to vaporize, heat and dissociate most of the ammonia by efficient heat exchange between the flue gas and the ammonia fuel under the combustion of the reformed fuel with oxygen. With the combination of oxy-ammonia combustion with a TCR heat recovery system, the disadvantage of utilizing ammonia fuel as an industrial fuel in a high temperature furnace is fully eliminated. The improved heat recovery efficiency is partly enabled by elimination of RFG blended with the ammonia fuel during the reforming cycle (excluding the purging cycle) as required in U.S. Pat. No. 6,113,874. Ammonia is conventionally transported in liquid form across the ocean by large liquid tankers. It is stored in liquid storage tanks on shore and then distributed. Liquid ammonia can be vaporized and transported in gaseous form in pipelines on land. When the same furnace is fired with gaseous ammonia [NH₃ (g)] and oxygen without any heat recovery system, fuel consumption is reduced to 4.1 GJ/t. However, when the same furnace is combined for the TCR heat recovery without blending RFG during the reforming cycle, the fuel consumption with gaseous ammonia is reduced to, 2.86 GJ/t, which is the same as the liquid ammonia case 4 shown at Table 1. Thus, it should be understood either gaseous or liquid ammonia can be used in the present invention. Additionally, bio-fuels with high water content require a large amount of heat for water evaporation and reduce the adiabatic flame temperature with air combustion. The flue gas contains a large fraction of water vapor and the sensible heat in the flue gas becomes large at high furnace gas temperature. Depending on the water content of the bio-fuel, the adiabatic flame temperature with air combustion may range from 1600° C. to 2000° C. In another aspect of the present invention, although not included in the examples shown in Table 1, the inventor has recognized and identified that low BTU bio-fuels with low adiabatic flame temperature similar to or below that of ammonia, preferably less than 1850° C. and more preferably less than 1800° C. are expected to produce similarly large fuel savings with a TCR heat recovery system. In the TCR liquid low BTU bio-fuel is heated and physically transformed to gaseous fuel (i.e., evaporation) in the low temperature zone and chemically transformed (i.e., dissociation) to a reformed fuel when heated to a sufficiently high temperature. Thus, ammonia fuels blended with low BTU bio-fuels at any mixture ratios are also contemplated by the present invention, as such blended fuels are expected to achieve substantially comparable fuel savings benefits that can be achieved with a TCR heat recovery system that utilizes ammonia.

TABLE 1
Fuel Consumption and savings with TCR
for CH₄, H₂, NH₃(1), and C₂H₅OH (1)

| | CASE NUMBER | | | |
|---|---|---|---|---|
| | 1 | 2 | 3 | 4 |
| FUEL | CH₄ | H2 | C2H5OH(I) | NH3(I) |
| FUEL CONSUMPTION | 3.52 | 3.53 | 3.56 | 4.53 |
| (GJ LHV/T) | | | | |
| FUEL CONSUMPTION | 2.85 | 2.95 | 2.86 | 2.85 |
| WITH TCR(GJ LHV/T) | | | | |
| FUEL SAVINGS | 19.0% | 16.3% | 19.6% | 37.2% |
| HEAT EXCHANGER | 50.4% | 40.9% | 51.8% | 74.1% |
| RECOVERY EFFICIENCY | | | | |

Both hydrogen and ammonia contain no carbon species and do not emit CO₂ from combustion. Since fuel availability and costs are important considerations, it would be desirable to be able to combust hydrogen and ammonia in any proportions in a furnace. Fuel requirements for hydrogen and ammonia mixtures are compared in table 2. Case 1 shows 100% hydrogen and Case 5 shows 100% ammonia. Cases 2, 3 and 4 show results of ammonia blended in hydrogen at 25%, 50% and 75% by molar ratio, or by volume in a gaseous state at 25 C, respectively. As more ammonia is blended into hydrogen, the fuel requirement increases when the furnace does not have the TCR heat recovery system. On the other hand, when ammonia is blended into hydrogen and the TCR heat recovery system is used, the calculated fuel consumptions are lower than that of the 100% hydrogen case in any blend ratios as shown in Cases 2, 3, 4, and 5. Thus, the present invention of blending ammonia into hydrogen up to 100% shows a benefit compared to 100% hydrogen firing. Although not shown in Table 2 blending as low as 10% ammonia by gaseous volume into hydrogen is expected to show a reduction in fuel requirement as compared to 100% hydrogen (Case 1).

TABLE 2
Fuel Consumption with and without TCR heat recovery system for H2-NH3 fuel blends

| | CASE NUMBER | | | | |
|---|---|---|---|---|---|
| | 1 | 2 | 3 | 4 | 5 |
| FUEL | H2 | H2/NH3(I) | H2/NH3(I) | H2/NH3(I) | NH3(I) |
| FUEL BLENDING | 100%/0% | 75%/25% | 50%/50% | 25%/75% | 0%/100% |
| BY MOLAR RATIO | | | | | |
| FUEL BLENDING | 100%/0% | 69%/31% | 43%/57% | 20%/80% | 0%/100% |
| BY LHV RATIO | | | | | |
| FUEL CONSUMPTION | 3.53 | 3.79 | 4.04 | 4.29 | 4.53 |
| WITHOUT TCR (GJ LHV/T) | | | | | |
| FUEL CONSUMPTION | 2.95 | 2.87 | 2.79 | 2.82 | 2.85 |
| WITH TCR (GJ LHV/T) | | | | | |

While it has been shown and described what is considered to be certain embodiments of the invention, it will, of course, be understood that various modifications and changes in form or detail can readily be made without departing from the spirit and scope of the invention. It is, therefore, intended that this invention not be limited to the exact form and detail herein shown and described, nor to anything less than the whole of the invention herein disclosed and hereinafter claimed. For example, although not included in the above examples, low BTU bio-fuels, preferably with an adiabatic flame temperature with air combustion of less than 1850° C. and more preferably less than 1800° C., can be a suitable blending fuel with hydrogen to reduce net CO₂ emission in accordance with the principles of the present invention. Examples of low BTU bio-fuels include raw ethanol produced from corn or sugarcane fermentation or bio-oils from pyrolysis of biomass materials containing large water fractions. In yet another example, as described in conjunction with Table 2, fuels with low adiabatic flame temperature increase the fuel requirement in high temperature furnaces. When the TCR heat recovery system is used, the fuel requirement becomes comparable to a high quality fuel like hydrogen. Hence, in another aspect of the present invention, by blending an ammonia fuel with a higher quality fuel (i.e., exhibiting a high adiabatic flame temperature) like natural gas in a TCR heat recovery process as has been explained herein and throughout, significant improvements in the heat recovery efficiencies are expected without using the RFG as required in U.S. Pat. No. 6,113,874.

What is claimed is:

1. A method of carrying out combustion in a furnace, comprising
(A) combusting a reformed fuel formed in step B (1) and step B (2) in the furnace with an oxidant comprising oxygen in a furnace to produce gaseous combustion products, and
(B) alternately
(1) passing the gaseous combustion products from the furnace into and through a cooled first regenerator to heat the first regenerator and cool said gaseous combustion products, and passing a fuel comprising ammonia into a heated second regenerator heated in step B (2) and, in the second regenerator, heating said fuel comprising ammonia and dissociating ammonia to form a reformed fuel, thereby cooling said second regenerator, and passing said reformed fuel from the second regenerator into the furnace and combusting the reformed fuel in the furnace, and
(2) passing the gaseous combustion products from the furnace into and through a cooled second regenerator to heat the second regenerator and cool said gaseous combustion products, and passing a fuel comprising ammonia into the heated second regenerator heated in step B(1) and, in the first regenerator, heating said fuel comprising ammonia and dissociating ammonia to form a reformed fuel thereby cooling said first regenerator, and passing said reformed fuel from the first regenerator into the furnace and combusting the reformed fuel in the furnace.

2. A method according to claim 1, wherein said fuel comprises 10% or more ammonia in lower heating value input.

3. A method according to claim 1, wherein said fuel comprises 50% or more ammonia in lower heating value input.

4. A method according to claim 1, wherein said fuel is ammonia in a liquid state.

5. A method according to claim 1, wherein said fuel is ammonia in a gaseous state.

6. A method according to claim 1, wherein said fuel comprises ammonia and hydrogen.

7. A method according to claim 1, wherein said fuel comprises ammonia and natural gas.

8. A method according to claim 1, wherein said fuel comprises ammonia and ethanol.

9. A method according to claim 1, wherein said fuel comprises ammonia and hydrogen.

10. A method according to claim 1, wherein said fuel comprises ammonia and bio-fuel.

11. A method according to claim 1, wherein said fuel comprises 50% or more low BTU fuel by lower heating value input.

12. A method according to claim 1, wherein said oxidant comprises at least 50 vol % oxygen.

13. The method according to claim 1, wherein none of said cooled combustion gases is utilized as a recycled flue gas (RFG).

14. A method of carrying out combustion in a furnace, comprising:
(A) combusting a fuel product with an oxidant comprising oxygen in the furnace to produce combustion products at a temperature above 1100° C.; and
(B) passing the combustion products from the furnace into a thermochemical regenerator system to transfer heat from said combustion products to an ammonia-based fuel;
(C) cooling said gaseous combustion products and heating said ammonia-based fuel, thereby allowing said ammonia-based fuel to dissociate into a fuel product;
(D) passing the fuel product into the furnace; and
(E) exhausting all of the cooled gaseous combustion products to a stack.

15. A method of carrying out combustion in a furnace, comprising:
(A) combusting with oxygen a reformed fuel formed in step B (1) and step B (2) in the furnace to produce gaseous combustion products at a temperature above 1100° C., and
(B) alternately
(1) passing the gaseous combustion products from the furnace into and through a cooled first regenerator to heat the first regenerator and cool said gaseous combustion products, and passing a fuel with an adiabatic flame temperature of less than 1850° C. into a heated second regenerator heated in step B (2) and, in the second regenerator, heating and transforming said fuel to form a reformed fuel, thereby cooling said second regenerator, and passing said reformed fuel from the second regenerator into the furnace and combusting the reformed fuel in the furnace, and
(2) passing the gaseous combustion products from the furnace into and through a cooled second regenerator to heat the second regenerator and cool said gaseous combustion products, and passing a fuel with an adiabatic flame temperature of less than 1850° C. into a heated first regenerator heated in step B (1) and, in the first regenerator, heating and transforming said fuel to form a reformed fuel, thereby cooling said first regenerator, and passing said reformed fuel from the first regenerator into the furnace and combusting the reformed fuel in the furnace.

16. A method according to claim 15, wherein said gaseous combustion products is at a temperature above 1250° C.

17. A method according to claim 15, wherein said gaseous combustion products is at a temperature above 1400° C.

18. A method according to claim 15, wherein said fuel has an adiabatic flame temperature of less than 1800° C.

19. A method according to claim 15, wherein said fuel is a low BTU bio-fuel.
